(19) United States
(12) Patent Application Publication
(10) Pub. No.: US 2004/0090628 A1
(43) Pub. Date: May 13, 2004

(54) Mappable atmospheric pollutant detection system

(76) Inventors: Oleg Ershov, Moscow (RU); Alexander Nadezdinskii, Moscow (RU); Andrey Berezin, Moscow (RU); Steven Kadner, Albuquerque, NM (US)

Correspondence Address: CARSTENS YEE & CAHOON, LLP, P O BOX 802334, DALLAS, TX, 75380

(21) Appl. No.: 10/293,836

(22) Filed: Nov. 13, 2002

(51) Int. Cl. G01N 21/59

(52) U.S. Cl. 356/438

(57) ABSTRACT

The present invention provides for an apparatus, method, and system for mapping out each pollutant and its locality. The apparatus includes a cell where pollutants can be collected in with an optical channel having multiple passes of radiation within the cell. The cell requires a valve acting like a vacuum for allowing pollutants in the atmosphere to be deposited in the cell for detection. A location sensor is provided for determining a location coordinate of the cell. The mappable atmospheric pollutant detection system utilizes laser technology with a computer system.

The optical scheme within the cell is capable of multiple passes of radiation in which the total length of radiation is multiple length of the cell. The multiple passes scheme conforms to Chernin's multipass matrix system. Chernin's multipass matrix includes a matrix of mirrors to create multiple passages of radiation within a confined space.

### BACKGROUND OF THE INVENTION

1. Technical Field

The present invention relates to detecting a molecule present in the air. More specifically the invention relates to a laser device for detecting pollutants. The device is controlled by a computer system.

2. Description of the Related Art

The colors of an object typically arise because materials selectively absorb light of certain frequency, while scattering or transmitting light of other frequencies. For example an object is red (wavelength range from 6300 and 6800 Å) if it absorbs all visible frequencies except those our eyes perceive to be “red.” Thus, we see the scattered wavelength range from 6300 and 6800 Å from that object.

Similarly, molecules absorb at different frequencies. A predefined range of wavelength propagating through gas molecules are absorbed at the resonance frequencies of the atoms or molecules, so that one observes gaps in the wavelength distribution of the emerging wavelengths. Absorption lines of a molecule have its own intensity and spectral position. In detecting a molecule using laser technology, the laser radiates frequencies near the absorption line to amplify the sensitivity of the detection.

The Clean Air Act requires every state to establish a network of air monitoring stations for criteria pollutant, following criteria set by the Environmental Protection Agency's (EPA) Office of Air Quality Planning & Standards (OAQPS). Then in 1990, Amendments to the Clean Air Act required monitoring stations to measure ozone precursors including but not limited to sixty (60) volatile hydrocarbons and carbonyl. Establishing these monitoring stations can be costly as new pollutants are being monitored in a changing society. New monitoring stations must be added as cities and their vicinities when an area becomes more populated with people and industries; existing monitoring stations may become obsolete as the desire to monitor the pollutants in the area cease. This patent describes a non-stationary monitoring system capable of detecting virtually all-molecular pollutants in the atmosphere utilizing laser technology.

### SUMMARY OF THE INVENTION

The present invention provides for an apparatus and system for mapping atmospheric pollutants. The apparatus includes a cell with an optical channel for laser technology in detecting atmospheric pollutants. Pollutants are deposited in the cell for analysis through a duct that directs airflow from the atmosphere to the cell. The data about the type of existing pollutants is correlated with a location coordinate. Therefore, where the cell is located and what type of pollutants is detected is known. Location coordinate is collected from a location sensor. The system includes a computer system with software analyzing the data and mapping the location of the pollutants.

The optical scheme within the cell is capable of multiple passes of radiation in which the total length of radiation is multiple length of the cell. The multiple passes scheme conforms to Chernin's multipass matrix system. Chemin's multipass matrix includes a matrix of mirrors in which the radiation systematically fall on the matrix of mirrors to create multiple passages of radiation within a confined space.

### BRIEF DESCRIPTION OF THE DRAWINGS

FIG. 1 is a block diagram of a pollutant detector system according to an embodiment of the present invention.

FIG. 2 is a block diagram of a pollutant detector according to an embodiment of the present invention.

FIG. 3 is a pictorial representation of a analytical multipass cell according to an embodiment of the present invention.

FIG. 4 is a diagram of a scheme of Field Mirror Block and Matrix m×n in accordance with an embodiment of the present invention.

FIG. 5 is a pictorial representation of a Upper platform in accordance with an embodiment of the present invention.

FIG. 6 is a pictorial representation of an optical channel of the adaptive optics for the multipass cell in accordance with an embodiment of the invention.

FIG. 7 is a block diagram of a diode laser block according to an embodiment of the present invention.

FIG. 8 is a block diagram of a computer system according to an embodiment of the present invention.

FIG. 9 is a block diagram of a pollutant detector controller according to an embodiment of the present invention.

FIG. 10 is a pictorial representation of an interface module according to an embodiment of the present invention.

FIG. 10(a) is a Diode Laser current supply in accordance with an embodiment of the present invention.

FIG. 10(b) is a resistance-voltage transformer in accordance with an embodiment of the present invention.

FIG. 10(c) is a pettier supply in accordance with an embodiment of the present invention.

FIG. 11 is a pictorial representation of a preamplifier unit in accordance with an embodiment of the invention.

FIG. 12 is a block diagram of software in accordance with an embodiment of the invention.

FIG. 13 is a flowchart of signal processing in accordance with an embodiment of the invention.

FIG. 14 is a flowchart for calculation of pollutant concentration in accordance with an embodiment of the present invention.

FIG. 15 is a flowchart for Diode Laser temperature stabilization in accordance with an embodiment of the present invention.

### DETAILED DESCRIPTION

The description of the preferred embodiment of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention the practical application to enable others of ordinary skill in the art to understand the invention for various embodiments with various modifications as are suited to the particular use contemplated.

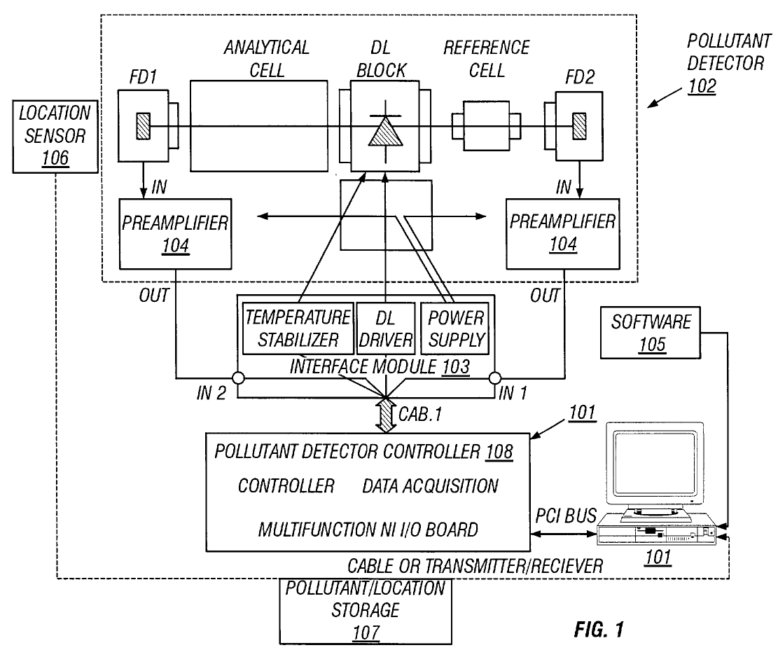

With reference now to the figures and in particular with reference to FIG. 1, a pictorial representation of pollutant detection system 100 in accordance with an embodiment of the present invention is illustrated. Pollutant detection system 100 includes computer system 101, pollutant detector 102, interface module 103, Preamplifier unit 104, software 105, location sensor 106, pollutant/location storage 107, and pollutant detector controller 108.

Pollutant detector 102 and location sensor 106 are capable of being attached to a vehicle (i.e. bus, truck, or car) or an airplane whether manned or unmanned for providing non-stationary detection of pollutants. Location sensor 106 is placed near or next to pollutant detector 102 for correlating the pollutant with the location in which the pollutant is detected. The correlated data including the type of pollutants and location coordinate may be stored in pollutant/location storage 107 for real time or later retrieval and analysis. With the data, a computer system with software may analyze the data and map out the location of the pollutants. In a preferred embodiment, location sensor 106 involves a Global Positional System (GPS) or a location sensor with a transmitter for location detection.

FIG. 2 presents the appearance of pollutant detector 102. Pollutant detector 102 includes three major components: analytical multipass cell 202, upper platform 204, and reference cell 206. Chemin's matrix system is applied as analytical multipass cell 202. In a preferred embodiment of the present invention analytical multipass cell 202 has the basic length 0.5 m and the optical path length can be retuned from 1 to 100 m. Analytical multipass cell 202 is coupled to the upper platform 204. The bottom 208 of the housing is detachable and coupled to analytical multipass cell 202 as well. Reference cell 206 is attached to upper platform 204.

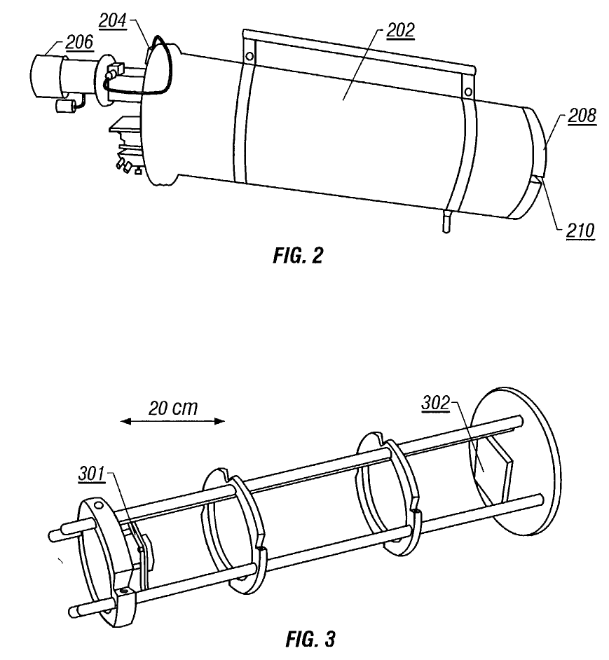

FIG. 3 shows the inside of analytical multipass cell 202 with Chemin's matrix system. It contains a block of objectives 301 having four objectives mirrors and a block of field mirrors 302 consisting of two field mirrors. The supporting rods of the multipass cell are coupled to the bottom 208 of the housing in order to reinforce the construction rigidity.

Chemin's multipass matrix system consists of two blocks of concave spherical mirrors located from each other at a distance of curvature radius. On the one side of the system, there is a block of four round mirrors (objectives) located symmetrically to the system central axis. On the opposite side, there are two field mirrors of a rectangular shape-main field mirror and the auxiliary field mirror.

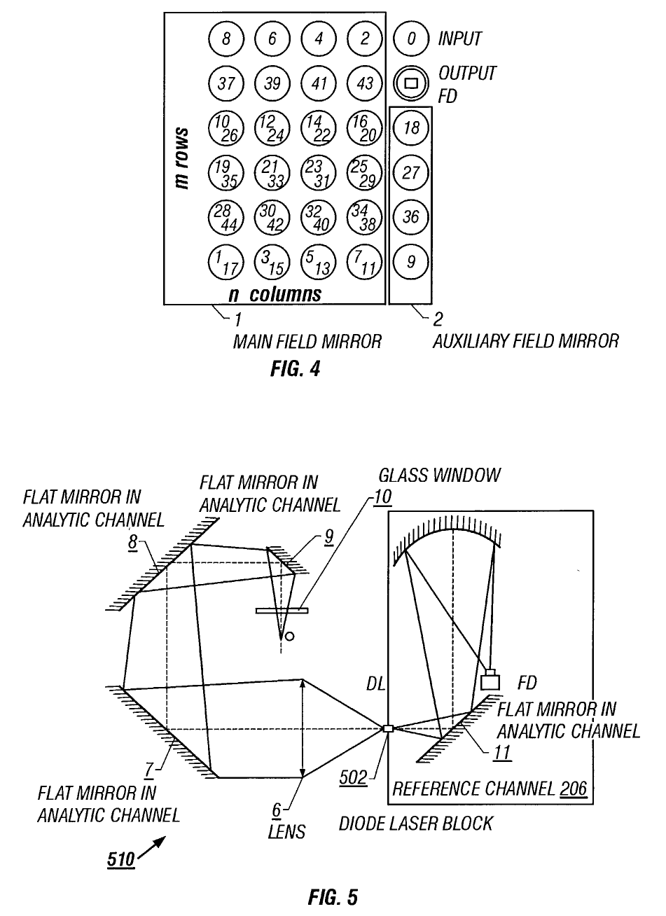

FIG. 4 shows an example of a scheme of Field Mirror Block and Matrix m×n of radiation focusing points with the radiation input of the system and the photodiode at the radiation output in the adjusted system. The matrix system operates as follows: The light beam focused on the system input (designated as number 0—Input) diverges and illuminates the first objective and is focused by the latter on point 1 on the main field mirror. Then radiation falls on the second objective positioned symmetrically relatively the system axis to the first one and is focused on point 2 on the field mirror. After several passages similar to the passages described above, two rows of focusing points appear on the main field mirror and radiation falls on the auxiliary field mirror (point 9 in FIG. 4) and goes over to the other pair of objectives, which form the next two rows on the field mirrors in a similar way. Longer length of radiation path amplifies the absorption of pollutants. The light beam is transferred from one pair of objectives to another for several times depending on the system adjustment and, finally, falls on the photodiode sensing square at the system output. In a preferred embodiment, a lens having 5 mm in diameter and 10 mm in focal distance is fixed in a special frame in front of the photodiode in order to make the system operation more stable.

As a result, the matrix m×n is formed from the radiation focusing points on the field mirrors. The number of passages in the system is calculated by the following formula:

N=(m−1)(4n−2),

where m stands for the number of rows and n stands for the number of columns.

The unique features of the system are that it is vibration-proof and easily adjustable for various passage numbers. In a preferred embodiment of the present invention, the mirrors in the analytical multipass cell 202 of the pollutant detector are copper-coated with a dielectric covering for the range of 1.3-1.7 μm acting also as a protective coating. The absorption value of a detected gas is proportional to the optical path length. However, at a larger number of light reflections from the mirrors, the signal at the output of the multipass cell decreases resulting in a lower signal/noise ratio. There is an optimal number of passages (dependent on the reflectivity of the system mirrors), which is equal to 90 for this very system (matrix 6×5), the optical path length being 45 m when the cell length is 50 cm.

FIG. 5 presents a pictorial representation of the Upper platform 204. The following units are installed on the platform: DL block 503, reference cell 206, analytical coupling optics 510 for DL radiation before input into analytical multipass cell 202.

Diode laser (“DL”) 503 and thermistor 504 are fixed (a rather good thermal contact being achieved) on copper holder installed at the top of a Peltier element 505 as depicted in FIG. 7. Diode laser 503 radiating power is proportional to transformed DL current 509. The frequency range of laser radiation is tuned by changing and stabilizing the DL temperature. Peltier element 505 and thermistor 504 assist in adjusting and stabilizing the temperature of diode laser 503 such that the emitted wavelength stays near a specified pollutant's absorption line. Initially, thermistor 504 sets the temperature for diode laser 503 with the raw resistance voltage 508. Peltier element 505 controls the temperature either by removing the heat by pumping heat away from the chamber adjacent to a device or adding heat to that chamber. Diode laser 503, Peltier element 505, and thermistor 504 may be housed inside thermostatic enclosure 506. Thermostatic enclosure 506 helps to keep the temperature of the assembly constant without the effect of the changing temperature of the outside environment.

The design of the device is based on the DL chip 503 capability to radiate in two opposite directions. The direct DL radiation goes into a retunable multipass optical cell with a photoreceiver at its exit. This channel is called analytical (e.g. 510 and 202). The opposite DL radiation passes twice through a closed reference cell 209 (filled with a preset concentration of pollutant) and falls onto another photoreceiver. This channel is called reference. The photoreceivers are produced as an entire block of germanium photodiodes and preamplifiers.

Turning back to FIG. 5, analytical coupling optics 510 involves optical channel with radiation from DL passes in a straight direction through lens (6) and the system of three flat mirrors (7, 8, 9) and goes into the multipass cell through glass window (10). The coupling optics 510 of the multipass cell is calculated and constructed in such a way so that the radiation from DL 503 can be focused on the plane of field mirrors at the entrance of the analytical multipass cell 202 at point O and illuminates the first of the objectives.

In a reference optical channel, DL radiation in an opposite direction is reflected by flat mirror (11), passes through reference cell 209, falls onto the spherical mirror located inside the reference channel housing, passes reference cell 209 again and is focused on the photodiode sensing square. Such units as laser block socket, socket for power supply of both photoreceiver preamplifiers, connector plugs, for 50-ohm cables of preamplifier outputs and electrical branch box are located on the upper platform 204 as well.

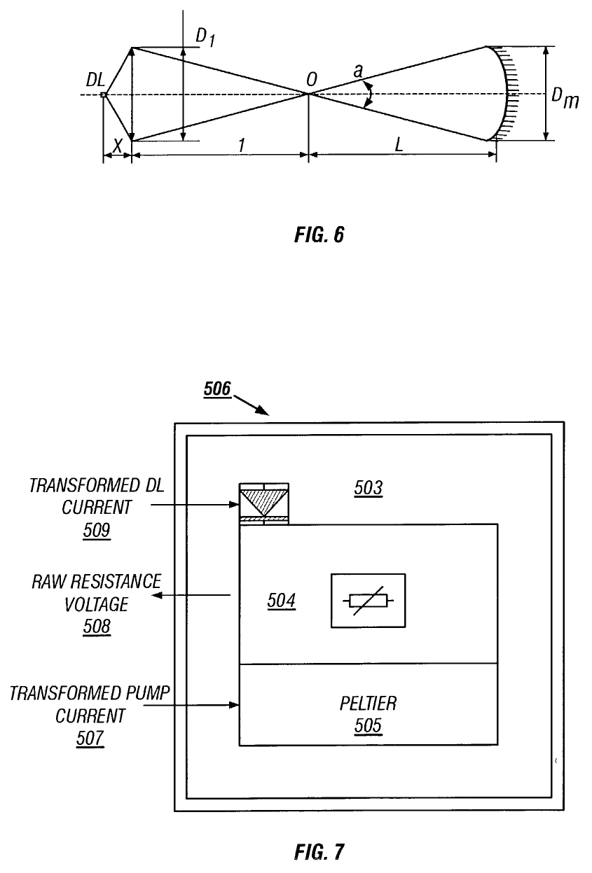

Referring to FIG. 6, the aperture of the incoming beam for analytical multipass cell 202 is determined by the objective diameter Dₘ (45 mm) and by the distance between the mirror systems in the multipass cell L (500 mm) and equals 1:11.

At a preset calculated diameter of the lens Dₗ (30 mm), the distance l between the lens and the focusing point O is determined by the formula:

l=L*Dₗ/Dₘ=333 mm.

Subject to the preset calculated focal distance of the lens with a focus length of f (48 mm), the distance between DL 503 and lens is determined by the formula:

X=f*l/(l−f)=56 mm.

In a preferred embodiment of the present invention, the aperture of the DL beam directed into the analytical channel is Dₗ/X=1:2 which means that more than 60% of the direct laser radiation power being captured within this aperture. The reference channel does not need to hold a large capture of DL radiation since it has no high losses: the aperture of DL radiation in the opposite direction is 1:8 (about 15% of opposite DL radiation power).

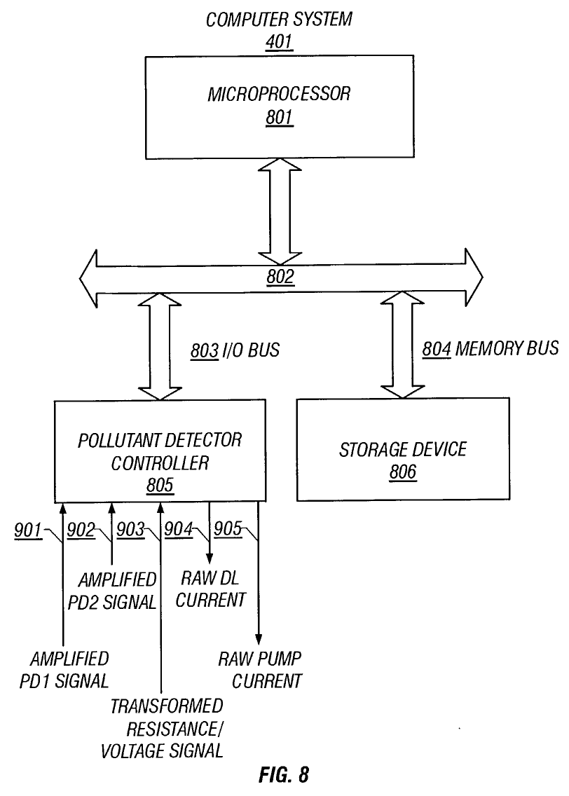

Referring now to FIG. 8, a block diagram of a computer system 101 is shown in accordance with a preferred embodiment of the present invention. Computer system 101 may employ a single microprocessor 801, or in the alternative, multiple microprocessors on the system bus 802. A storage device is connected to a memory bus 804. A storage device includes memory devices such as hard disk drive 806. An input/output (“I/O”) device may be integrated to the I/O bus 803 as depicted. I/O device includes a pollutant detector controller 805 for assisting in the control of pollutant detector 102. Computer system 101 controls and communicates with the pollutant detector.

Those of ordinary skill in the art will appreciate that the hardware depicted in FIG. 8 may comprise of multiple microprocessors, multiple storage devices, or multiple I/O devices. These devices may vary. For example, other peripheral devices, such as optical disk drives and the like, also may be used in addition to or in place of the hardware depicted. The depicted example is not meant to imply architectural limitations with respect to the present invention.

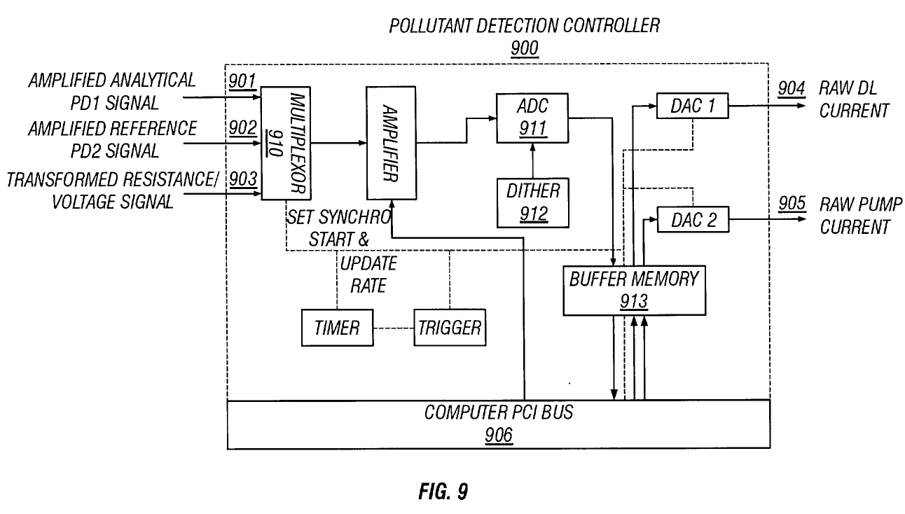

Referring now to FIG. 9, a block diagram of a pollutant detector controller 805 is illustrated. A multiplexor 910 allows successive connecting of inputs to analog to digital converter (“ADC”) 911 with set update rate, which value can't exceed a predetermined sampling frequency used in this device, 1.25 MHz. Next, dither 912 may be used for smoothing of bits in ADC 911 output signals. A timer controlled by software serves as clock cycle for pollutant detector controller 805. It may include a frequency divider that allows for frequency adjustments of output signal generation and data acquisition. A trigger is controlled by the timer. It serves as a synchronization signal for the signal generation and data acquisition. If this triggering synchronization switches at a common frequency, it creates an operational frequency for the pollutant detector controller 805.

With regards to controller's outputs, data are stored in buffer memory 913. A predetermined pulsed signal for DL current pulse is stored in buffer memory 913 for DL current. The data stored in the buffer memory 913 flows to the first digital-to-analog converter (“DAC1”). DAC1 supplies continuous train of raw DL current pulses 904. Controller 805 is installed in the computer PCI bus 906 and connected with Interface module 103 (e.g. raw DL current 904) and preamplifier 104. Data exchange between controller 805 and computer through reads and writes of controller's 805 buffer memory 913. In a preferred embodiment of the present invention, controller 805 is configured from a standard multifunctional NI-DAQ board of the PCI-MIO-16E-1 produced by National Instruments, Inc.

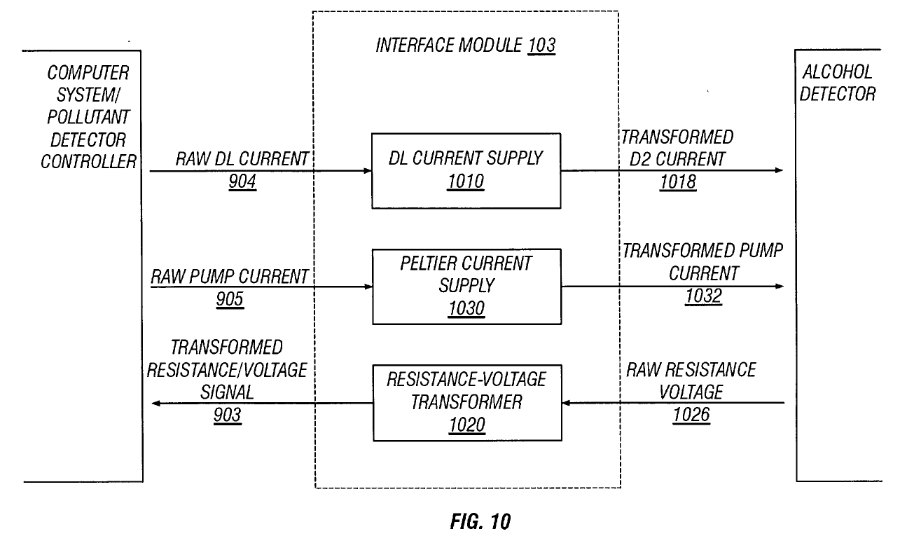

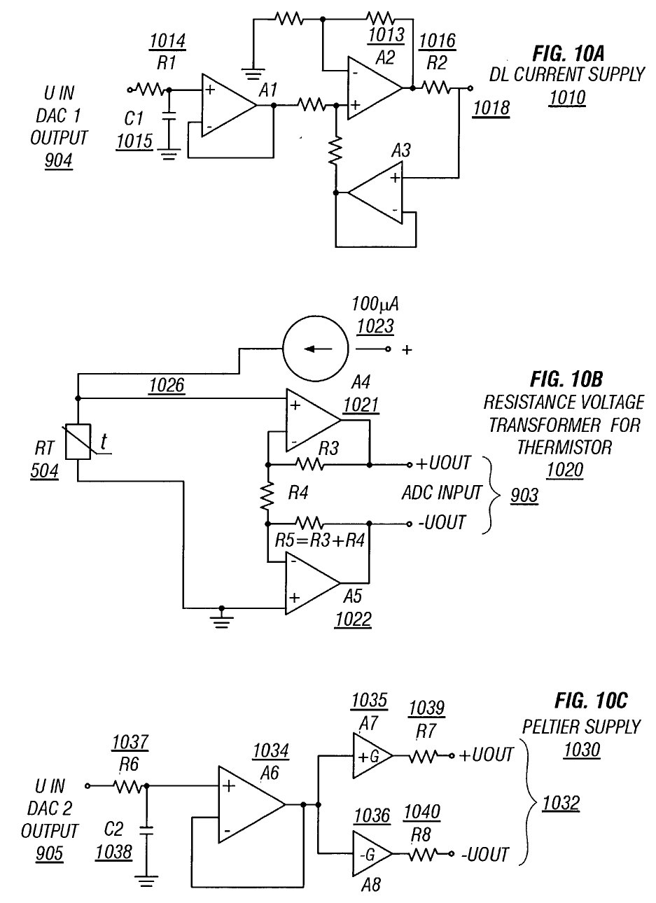

Referring now to FIG. 10, a pictorial representation of interface module 103 in accordance with an embodiment of the present invention is illustrated. Interface module 103 involves three analog units: DL current supply 1010, resistance-voltage transformer 1020, and Peltier current supply 1030. Interface module 103 provides interface for three signals between pollutant detector 102 and pollutant detector controller 805. In FIG. 10(a), DL current supply 1010 amplifies and transforms the pulse of raw DL current 904 into pulses of amplified DL current 1018 feeding optical channel. It includes three operational amplifiers, 1011-1013. Resistance R1 1014 and capacitance C1 1015 define frequency bandwidth. Resistance R2 1016 defines the current/voltage transformation factor. The output operational amplifier A₂ 1013 and resistor R₂ 1016 are chosen thermo stable for preventing drift of output parameters.

Two other units of interface module 103, resistance-voltage transformer 1020 is intended for stabilizing and adjusting the diode laser temperature. The temperature of thermistor having good thermal contact with diode laser 503 is measured in the Resistance-voltage transformer unit 1020 as depicted in FIG. 10(b). Resistance-voltage transformer unit 1020 includes two operational amplifiers 1021 and 1022 and stable current supply 1023. Current supply 1023 ensures that a current of 100 uA flows the thermistor Rₜ 504. Resistance-voltage transformer unit 1020 transforms raw resistance-voltage signal 1026 into a voltage value for transformed resistance-voltage signal 903 (see FIG. 8). Transformed resistance-voltage signal 903 transmits to Controller 805 (FIG. 8) as one of the inputs, which is later transformed into degree value in the device software.

In FIG. 10(c), the raw pump current 905 from pollutant detector controller 805 is transmitted to Peltier current supply 1030 of the Interface module 103 (FIG. 8). Peltier current supply 1030 constitutes a power amplifier for supplying differential voltage for transformed pump current 1032. The unit includes three operational amplifiers, 1034-1036, resistance R₆ 1037 and capacitance C₂ 1038, which restrict frequency bandwidth, resistances R₇ 1039 and R₈ 1040, which restrict maximum output current for transformed current supply 1032. All units of the Interface module 103 are storage battery-powered; the batteries being very stable sources. Such independent power supply ensures stable operation and high values of a signal to noise ratio.

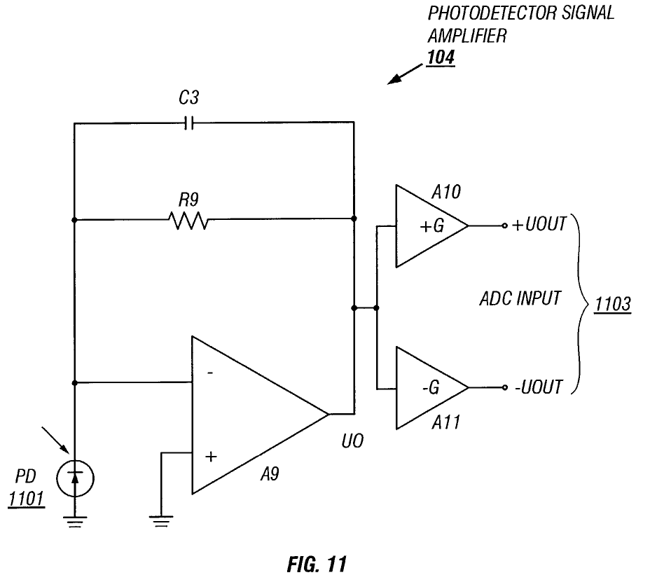

Referring now to FIG. 11, a pictorial representation of a preamplifier unit 104 in accordance with an embodiment of the present invention is illustrated. Preamplifier unit 104 transforms raw analytical PD1 signal 1101 into differential amplified analytical PD1 signal 1103. Amplified analytical PD1 signal 1103 is an input to Pollutant Detector Controller 805. Base scheme of these preamplifiers is shown at FIG. 11. The first stage of the scheme is typical transimpedance amplifier A9 where R9 and C3 are feedback resistance and capacitance respectively. Amplifier frequency bandwidth is defined by capacitance C3, transfer factor at low frequencies is defined by resistance R9. Second stage of the scheme is voltage amplifiers A10 and A11 for generating differential outputs. Preamplifier unit 104 is also battery-powered for providing high signal to noise ratio.

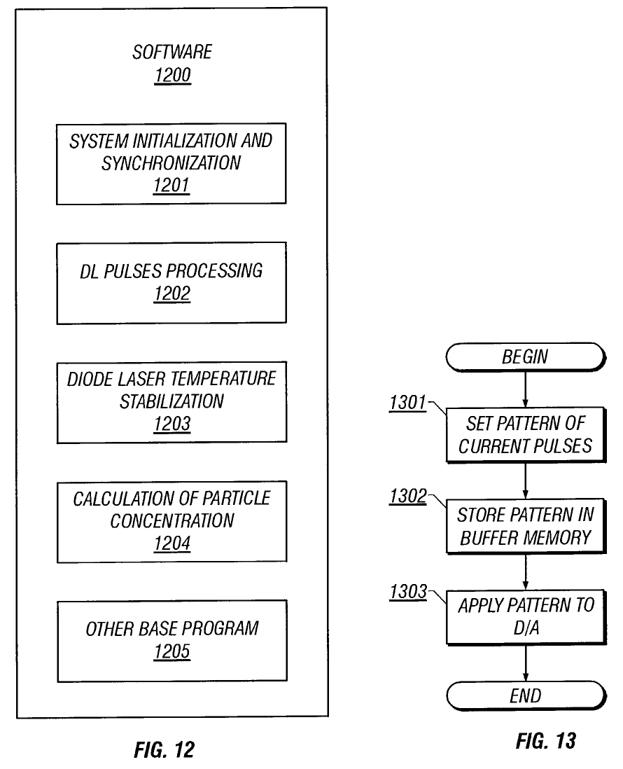

Referring now to FIG. 12, a block diagram of software 105 in accordance with an embodiment of the present invention is illustrated. Software 1201 initializes and synchronizes pollutant detector system 100. It also provides for pollutant detector system computer program instruction for DL pulses processing 1202, diode laser temperature stabilization 1203, calculation of pollutant concentration 1204 and other operations are produced in the base part of the program 1205.

Referring now to FIG. 13, a flowchart of signal processing 1202 according to an embodiment of the present invention is illustrated. The software provides instructions for signal processing for generating the pattern of pulses of DL current (step 1301). The pulse pattern period must in proportionate to the digital to analog converter update rate. The pattern is then stored in the pollutant detection controller's buffer memory (step 1302). The software further provides instructions for applying the pattern to the pollutant detection controller's digital to analog converter (step 1303).

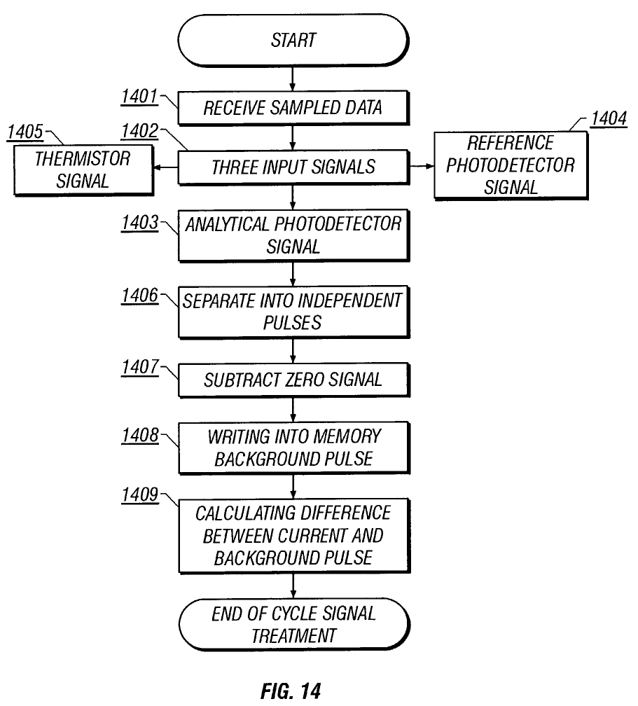

Referring now to FIG. 14, a flowchart for calculating pollutant concentration 1204 according to an embodiment of the present invention is illustrated. The process for calculating pollutant concentration starts with the receipt of sampled data from the analytical photoreceiver signal at beginning of the current pulse (step 1401).

The device uses DL operating in a pulse mode, the pulse duration being 1-10 msec with a minimal interval between two successive pulses (10-20% of duration). The current pulses feeding the laser are of a trapezoid shape. It ensures the sweep of DL radiation wavenumber within 1 cm⁻¹.

Subject to a correct tuning of DL temperature and current parameters, a pulsed signal obtained from the photoreceiver in a reference channel contains a peculiarity like a rather large dip (10-30% of a signal value) referred to as a selected pollutant absorption line. The signal obtained from the photoreceiver in an analytical channel can include not only peculiarities connected with a pollutant absorption line but also the dips referred to as absorption of other gases in a gas mixture under analysis. The frequency and contour parameters of an absorption line are unique features of a detected gas. The method of pollutant concentration measurement is based on the calculation of a correlation function of signal shapes in analytical and reference channels. It makes the device highly selective with respect to the other gases.

Three controller inputs (step 1402): (1) photoreceiver signal from analytical channel (step 1403), (2) photoreceiver signal from reference channel (step 1404), (3) signal proportional to thermistor resistance (step 1405), are used in present invention. They are applied to the controller ADC successively, so sampling frequency of each input is three times lower than the controller update rate. Pulse duration in photoreceiver signals includes 500 points, duration between adjacent pulses includes 100 points, so pulse repetition period includes 600 points.

The first channel contains sampled analytical PD1 signals made up of a train of pulses having 3.6 ms period (step 1403). The software separates the pulses for independent treatment of each pulse (step 1406) according to a period or cycle of a pulse. In step 1407, the value of “zero signal” between two pulses is subtracted from each of the points respectively. “Zero signal” is PD signal when laser is switched off. This signal includes photoreceiver preamplifier output shift and value connected with illumination of photoreceiver by other light sources. The result from subtracting zero signal is saved as background pulse (step 1408). Next the process calculates the difference between the background pulse and the raw current (step 1409).

Unique features of absorption spectrum of pollutant and reference in the range of wavelength scanning are used for their detection. The pollutant concentration is calculated as to be proportional to the correlation function between analytic and reference channel's signals.

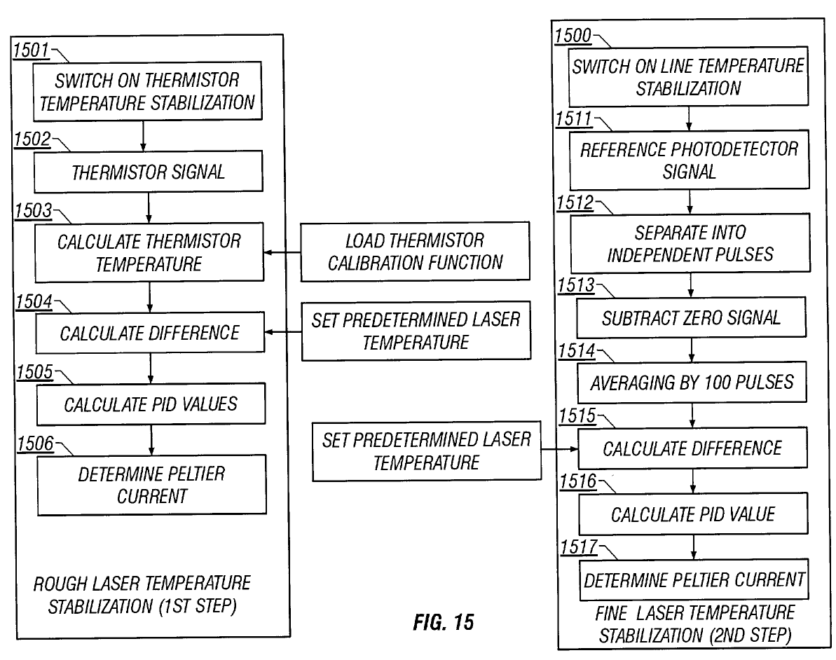

Referring now to FIG. 15, a flowchart for DL temperature stabilization 1203 according to an embodiment of the present invention is illustrated. Initially, the diode laser's temperature is set with the help of the thermistor (step 1501). First the process receives the transformed resistance/voltage signal (step 1502) from thermistor. With a predetermined load thermistor calibration function, the thermistor's actual temperature can be calculated (step 1503). Then with a set predetermined laser temperature and thermistor's actual temperature, the process calculates the temperature difference (step 1504). Next, the process calculates the PID (Proportion, Integral, Derivative) value (step 1505) in order to determine the pump current (step 1506). Initially, the diode laser and thermistor should have the same temperature until the diode laser generates more heat in which the temperature of the two components differs. As a result, thermistor's temperature is stabilized and not the diode laser. After the initial setting of the temperature, the process switches to line stabilization position (step 1510) for stabilizing DL temperature. The absorption line position within a recorded pulse is an unbiased criterion of DL true temperature. First, it receives the sampled data from amplified reference PD2 signal (step 1511). Each pulse is separated from the other (step 1512) for subtraction from zero signal (step 1513). The process repeats step 1513 one hundred times (100×) for one hundred pulse period before it takes the average value (step 1514). Next, with a preferred predetermined laser temperature and the calculated average value, the temperature difference is calculated (step 1515). Then the PID value must be calculated (step 1516) before the determination of pump current (step 1517). The difference between current absorption line position and predeterminated one come to the input of PID (Proportion, Integral, Derivative) program module. Value from output of this module is applied to DAC 2 for feeding Peltier element. This value at n step of the program cycle (Vₙ) is calculated in conformity with formula:

Vₙ=a*Pₙb*Iₙ+c*Dₙ

where Pₙ is the difference (see above) at n step of the program cycle,

$${I}_{n} = {\sum }_{0}^{n} {P}_{i} ,$$

Dₙ=Pₙ−Pₙ₋₁,a,b,c−PID factors.

Because pump current is not constant and must be determined, pump current is tunable and directly stabilizes DL temperature. The determined pump current is applied to DAC2 on the controller in which the pump current is made continuous before channeling to the interface module. DL temperature variations directly affect the DL radiation wavelength variation. The stabilization of DL temperature ensures that DL will operate in the stable range near the maximum pollutant absorption line.

Those of ordinary skill in the art will appreciate that the detector is capable of detecting methane or other low-molecular gases like CO, CO₂, H₂O, C₂H₂, etc. by replacing a diode laser 503 and switching over the device mode. For an example, a pollutant detector to detect methane is designed for measuring methane concentrations using a diode laser by registering one of absorption lines in the near IR region. The main purpose of the detector is the monitoring of methane content in the air inside a device optical cell (an average background methane concentration in the air in the vicinity of the Earth surface is 1.6 ppm) with the accuracy better than background level. The device allows measurements both in the open and closed cells by filling the cell with various gas samples or by pumping gases through closed cell. The device is automatically controlled by a personal computer; the device can operate for a long period of time (days, weeks) storing the data in the computer memory. The pollutant detector is a portable device and, hence, can be used for monitoring in the field, both in the stationary conditions and in a vehicle or aircraft.

Those of ordinary skill in the art will also appreciate that the detector is capable of detecting pollutants by the above optical channel incorporating Tunable Diode Laser Spectroscopy.

Although preferred embodiments of the present invention have been described in the foregoing Detailed Description and illustrated in the accompanying drawings for pollutant detection, it will be understood that the invention is not limited to the embodiments disclosed, but is capable detecting other gas molecules which may require numerous rearrangements, modifications, and substitutions of steps without departing from the spirit of the invention. For example, each gas molecule having distinct absorption line would require a diode laser radiating at or near that line, the photo receiver functions at the distinct absorption line, the predetermined DL current may differ in the sampled points and duration, the reference cell may differ in content. etc. Accordingly, the present invention is intended to encompass such rearrangements, modifications, and substitutions of steps as fall within the scope of the appended claims.

What is claimed:

1. An apparatus for mapping atmospheric pollutants comprising:
a cell with a first optical channel wherein said first optical channel detects atmospheric pollutants;
a valve to direct an airflow from the atmosphere into said cell wherein pollutants deposit into said cell for detection; and
a location sensor for determining a location coordinate for said cell.

2. The apparatus as recited in claim 1 further comprises:
a diode laser for emitting radiation that is tunable over a maximum absorption line of said pollutants; and
a multiple passes of radiation wherein the total length of radiation is multiple length of said cell.

3. The apparatus as recited in claim 1 wherein said multiple passes conforms to Chernin's multipass matrix system.

4. The apparatus as recited in claim 2 wherein said optical channel further comprises:
a first connection for a first current into said diode laser for radiation intensity; and
a second connection for a second current for adjusting the temperature of said diode laser.

5. The apparatus as recited in claim 4 wherein said second current is tunable over an absorption line of pollutant.

6. The apparatus as recited in claim 1 further comprises a second optical channel outside of said cell wherein said second optical channel detects atmospheric pollutants and wherein radiation passes from said second optical channel to first optical channel and wherein said second optical channel includes multiple passes.

7. The apparatus as recited in claim 6 further comprises a third optical channel for reference from the first or second optical channel.

8. The apparatus as recited in claim 1 further comprises:
a diode laser for emitting radiation at a maximum absorption line of said pollutants on two ends;
a first receiver detecting the presence of said pollutant from said first or second optical channel; and
a second receiver for reference from said third optical channel.

9. The apparatus as recited in claim 1 wherein said cell further couples with an air vacuum for directing air from the atmosphere into said cell wherein maximum pollutants deposits in said cell.

10. The apparatus as recited in claim 1 wherein said location sensor includes a Global Positioning System.

11. The apparatus as recited in claim 1 wherein mapping atmospheric pollutants is in realtime.

12. A method for mapping atmospheric pollutants comprising:
installing a pollutant detector on a vehicle;
coupling a location sensor with said pollutant detector;
correlating pollutants with the location of said pollutant detector; and
mapping pollutants with the location of said pollutant detector.

13. The method as recited in claim 12 further comprises:
collecting pollutants into a cell;
detecting pollutants in said cell;
saving the location and correlated pollutant data; and
analyzing said data.

14. The method as recited in claim 12 wherein mapping pollutants with the location of said pollutant detector is in real time.

15. A computer system for controlling a mappable pollutant detector, said computer system comprising:
a microprocessor for running software wherein the software analyzes the data from photoreceivers, maps location of pollutants, and controls said pollutants detector;
a pollutants detector controller for transforming data between said pollutant detector and the computer system; and
a storage device for storing predetermined diode laser pulsed current and analyzed data.

16. A computer system as recited in claim 15 wherein said pollutant detector further comprises:
an analog to digital converter for sampling inputs into digitized data for storage in said computer system wherein said digitized data will be analyzed according to an absorption line of said pollutants; and
a digital to analog converter for converting stored data into continuous data, wherein the continuous data couples to an input of said pollutant detector.

17. A pollutants detector system with a pollutant detector, said system comprising:
a pollutant detector wherein results of detection is in real time and correlated to a location coordinate;
a computer system for running a software wherein the software analyzes the data, maps location of pollutants, and controls said pollutants detector; and
an interface connecting said computer system and said pollutants detector.

18. A pollutants detector system as recited in claim 17, wherein said interface comprises:
a diode laser supply transforming pulsed diode laser current for pollutant detector;
a resistance-voltage transformer providing good thermal contact with diode laser;
a peltier current supply providing power amplifier for pump current; and
a preamplifier unit for interfacing between a photoreceiver and pollutants controller.

19. The computer program product in a computer readable medium for mappable pollutants detector comprising:
instructions for signal processing for generating the diode laser current pulses;
instructions for stabilizing diode laser temperature wherein diode laser radiation is tunable by adjusting the temperature of said diode laser;
instructions for calculating pollutants concentration detected by said pollutants detector; and
instructions for mapping location of pollutants.

20. The computer program product recited in claim 19, where in said instructions for signal processing further comprises:
first instructions for setting pattern of current pulses;
second instructions for storing pattern in a buffer memory; and
third instructions for applying pattern to a digital to analog converter.

21. The computer program product recited in claim 19, wherein said instructions for temperature stabilization further comprises:
first instructions for setting initial diode laser temperature by thermistor;
second instructions for switching to line stabilization position;
third instructions for receiving signal from reference signal;
fourth instructions for calculating the line position of the reference signal;
fifth instructions for determining Peltier current from the line position; and
sixth instructions for applying Peltier current to a digital to analog converter.

22. An apparatus for detecting atmospheric pollutants comprising:
a cell with a first optical channel wherein said first optical channel detects atmospheric pollutants; and
a multiple passes of radiation within said cell wherein the total length of radiation is multiple length of said cell wherein said multiple passes conform to Chemin's multipass matrix system.

23. The apparatus as recited in claim 22 further comprises:
a diode laser for emitting radiation that is tunable over a maximum absorption line of said pollutants; and
a valve to direct an airflow from the atmosphere into said cell wherein pollutants deposit into said cell for detection;

24. The apparatus as recited in claim 22 wherein said Chemin's multipass matrix system includes:
a matrix of main field mirrors; and
a set of auxiliary field mirrors wherein said radiation systematically falls on the mirrors creating multiple passages across said cell wherein the absorption of pollutants is amplified.

25. The apparatus as recited in claim 24 wherein a number of passages correlates to said matrix dimensions.

26. The apparatus as recited in claim 22 wherein said optical channel further includes:
a first connection for a first current into said diode laser for radiation intensity; and
a second connection for a second current for adjusting the temperature of said diode laser.

27. The apparatus as recited in claim 26 wherein said second current is tunable over an absorption line of pollutant.

28. A method for detecting pollutant comprising:
installing a pollutant detector on a vehicle;
collecting said pollutant into a cell;
detecting said pollutant in said cell; and
analyzing pollutant data.

29. The method as recited in claim 28 wherein detecting said pollutant further includes multiple passes of radiation within said cell wherein the total length of radiation is multiple lengths of said cell wherein said multiple passes conforms to Chemin's multipass matrix system.

30. The method as recited in claim 28 wherein said Chemin's multipass matrix system includes:
a matrix of main field mirrors; and
a set of auxiliary field mirrors wherein said radiation systematically falls on the mirrors creating multiple passages across said cell wherein the absorption of pollutants is amplified;

31. The method as recited in claim 30 wherein a number of passages correlates to said matrix dimensions.
